(19) United States
(12) Patent Application Publication
(10) Pub. No.: US 2003/0112152 A1
(43) Pub. Date: Jun. 19, 2003

(54) Robotic vehicle and method for soil testing

(76) Inventor: Terence D. Pickett, Waukee, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/024,907

(22) Filed: Dec. 19, 2001

(51) Int. Cl. H04Q 9/00; G08C 19/22

(52) U.S. Cl. 340/870.07

(57) ABSTRACT

An automatic method for soil sampling and analysis is provided using a robotic vehicle. The vehicle includes a ground drive system for moving the robot over the field. A control unit controls the steering and location of the robot. A tool package on the robot has one or more probes for taking soil samples, which are conveyed to a miniature lab on the robot for analyzing the soil sample. A processor generates data from the soil analysis, and the data is transmitted to a remote site for storage and later use. The processor includes software for moving the robot, sampling the soil at desired targets, analyzing the soil, and communicating the data to the remote site.

### BACKGROUND OF THE INVENTION

Soil testing is common and necessary in the agricultural industry to determine the soil type and nutrient levels such that crop production can be maximized. Typically, soil testing requires that soil samples or specimens be taken in the field, and then shipped off-site for laboratory analysis. A person normally operates the soil sampling machine or vehicle and records the location where the samples are taken. This prior art soil testing process is time consuming and expensive, due to the manpower requirements to operate the machine and the delays in transferring the samples from the test site to the remote laboratory for analysis.

Therefore, the primary objective of the present invention is the provision of an automatic system for collecting and analyzing soil samples in the field and transmitting data about the soil analysis to a remote site.

Another objective of the present invention is the provision of an unmanned, robotic vehicle which can be moved through a field using GPS technology, with a soil probe for taking soil samples, a lab for analyzing the samples, a processor for generating soil data, and a transmitter for transmitting the data to a remote site.

A further objective of the present invention is the provision of a method for automatic soil sampling using a robot platform which takes and analyzes the soil sample, generates data about the soil sample, and transmits the data to a remote site.

These and other objectives will become apparent from the following description of the invention.

### BRIEF SUMMARY OF THE INVENTION

The robotic vehicle of the present invention is used for sampling and analyzing soil in the field. The robot includes a ground drive system for moving the robot over the ground, and a control unit with GPS for controlling the ground drive system and steering the vehicle. The vehicle includes a probe for taking soil samples and a lab for analyzing the soil samples. A processor is provided on the vehicle for generating data from the soil analysis, and a transmitter then transmits the data to a remote site.

The method of the present invention includes the steps of moving the robot platform or vehicle over the soil, taking soil samples using the soil probe on the robot, analyzing the soil sample in a lab on the robot, generating data from the soil analysis, and transmitting the data to a remote site. These steps are performed autonomously without human intervention.

### BRIEF DESCRIPTION OF THE DRAWINGS

FIG. 1 is a block diagram illustrating the various modules which operate the robotic vehicle of the present invention.

FIG. 2 is a schematic perspective view of the robotic vehicle.

### DETAILED DESCRIPTION OF THE INVENTION

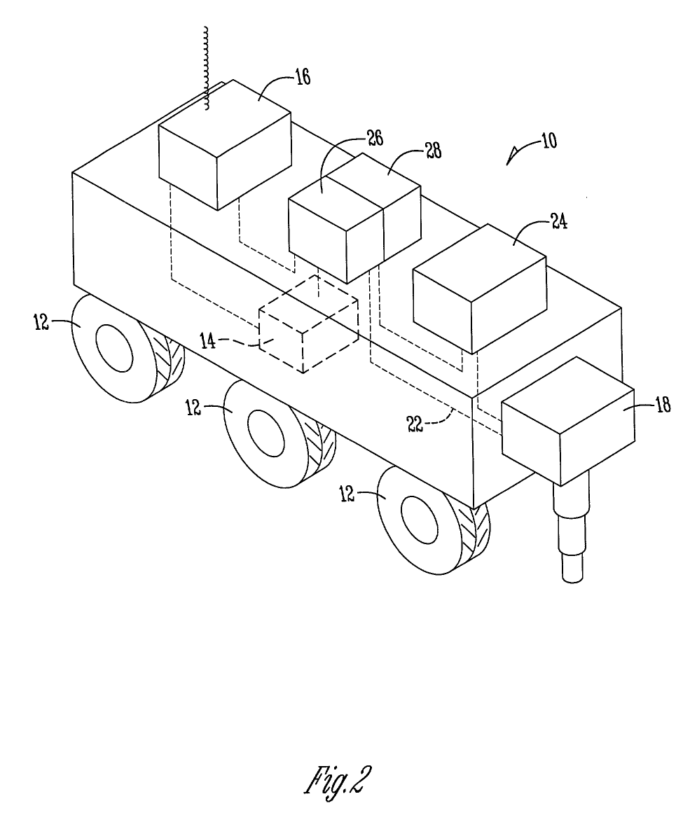

The present invention is directed towards a method and robotic vehicle for sampling and analyzing soil. The robotic vehicle or platform is generally designated in FIG. 2 by the reference numeral 10. The robot 10 includes a plurality of wheels 12 or other propulsion means which are rotatably driven by a ground drive system 14, which may include a diesel, gas, electric, or hybrid engine. The ground drive system 14 is controlled by a control unit 16. The control unit 16 includes a global positioning system (GPS) which could be used in conjunction with other location technologies.

The robot 10 includes a tool package 18 having one or more soil probes 20. The probes 20 may be of any conventional construction so as to be insertable into the soil to withdraw a sample or specimen therefrom. It is understood that the tool package 18 may be interchanged with other tool packages, including different probes 20, as needed for different types of soil or analysis operations.

Each soil sample taken by the probe 20 is conveyed by a conveyor 22 to a lab 24 on the robot 10. The lab 24, preferably a miniaturized wet-lab, automatically performs an analysis of the soil samples.

A programmed processor 26 is operatively connected to the lab 24 for generating data regarding the soil sample analysis. The processor 26 also includes path planning software operative with the GPS control unit 16 for navigation of the robot 10 in the field. A transmitter 28 operatively connected to the processor 26 then transmits the data to an off-site location for storage and later use, using radio frequency (RF).

Operation of the tool package 18, including the probe 20, is controlled by the processor 26. Similarly, the processor 26 controls the activation and deactivation of the ground drive system 14.

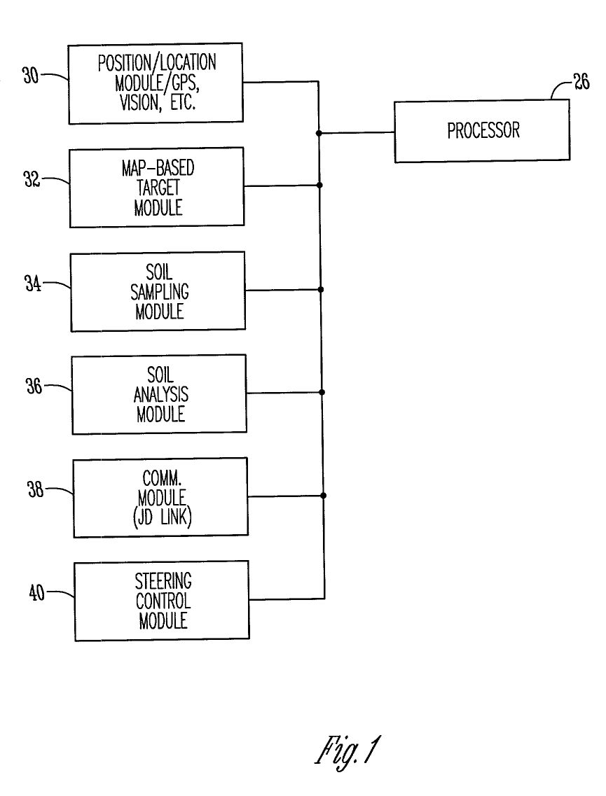

The software program for the processor 26 includes various modules, as shown in FIG. 1. More particularly, a first module 30 is provided for interaction between the processor 26 and the control unit 16 for determining position and location using GPS or other vision technology. A second module 32 provides a map-based target to allow the soil samples to be taken at desired locations. The soil sampling module 34 interacts between the processor 26 and the tool package 18 to control sampling of the soil. The soil analysis module interacts between the processor 26 and the lab 24 to generate the soil data. The communication module 38 interacts between the processor 26 and the transmitter 28 such that the soil data can be transmitted to the remote site. The steering control module 40 interacts between the processor 26 and the ground drive system 14 for steering the robot 10 in the field.

The method for automatic soil sampling and analysis according to the present invention includes the steps of moving the robotic vehicle or platform 10 over the soil, and taking one or more soil samples using the soil probe or probes 20 of the tool package 18. The soil sample or samples are then conveyed by the conveyor 22 to the lab 24 and analyzed therein. Data from the soil analysis is generated by the processor 26 and transmitted to the remote site by the transmitter 28. The entire sampling and analysis operation, including the data generation and transmission, is performed autonomously, without human intervention, by the unmanned robotic vehicle 10. Thus, there are cost savings compared to prior art manned soil sampling operations.

The communication capabilities of the robot 10 allow the robot to perform the soil sampling and analysis mission in a bounded area, and then shut down and wait for pick up after completion of the operation.

From the foregoing, it can be seen that the apparatus and method of the present invention substantially reduces the cost of soil analysis, and can increase the number of samples analyzed to improve the granularity of the resulting data. Additional packages may be added to the robotic vehicle 10 for determining the type and level of pest or fungal infestation, to allow producers to react more quickly, with a more targeted approach to pest management.

Whereas the invention has been shown and described in connection with the preferred embodiment thereof, it will be understood that any modifications, substitutions, and additions may be made which are within the intended broad scope of the following claims. From the foregoing, it can be seen that the present invention accomplishes at least all of the stated objectives.

What is claimed is:

1. A method for automatic soil sampling and analysis, comprising:
a) moving a robot platform over the soil;
b) taking a soil sample using a soil probe on the robot platform;
c) analyzing the soil sample in a lab on the robot platform;
d) generating data from the soil analysis; and
e) transmitting the data to a remote site.

2. The method of claim 1 further comprising controlling movement of the robot platform with a global positioning system or other location systems or a combination of several location systems.

3. The method of claim 1 wherein steps a-e are performed automatically without human intervention.

4. The method of claim 1 wherein steps a-e are performed autonomously.

5. A robot for sampling and analyzing soil, comprising:
a ground drive system for moving the robot over the ground;
a control unit for controlling the ground drive system;
a probe for taking a soil sample;
a lab for analyzing the soil sample;
a processor for generating data from the soil analysis; and
a transmitter for transmitting the data to a remote site.

6. The robot of claim 5 wherein the control unit includes a global positioning system.

7. The robot of claim 5 wherein the robot is unmanned.

8. The robot of claim 5 wherein the control unit steers the robot.

9. The robot of claim 5 further comprising a conveyor for conveying the soil sample to the lab.

10. The robot of claim 5 wherein the processor is operatively connected to the ground drive system to activate and deactivate the ground drive system.

11. The robot of claim 5 wherein the processor is operatively connected to the control unit for automatic movement of the robot.

12. The robot of claim 5 wherein the processor is operatively connected to the lab for automatic analysis of the soil sample.

13. The robot of claim 5 wherein the processor is operatively connected to the transmitter for automatic transmission of the data.

14. The robot of claim 5 wherein the transmitter uses radio frequency or cell phone technology to transfer the data.
